(19) United States
(12) Patent Application Publication
(10) Pub. No.: US 2009/0204885 A1
(43) Pub. Date: Aug. 13, 2009

(54) AUTOMATED MANAGEMENT AND PUBLICATION OF ELECTRONIC CONTENT FROM MOBILE NODES

(76) Inventors: Thomas N. Ellsworth, Northridge, CA (US); Carmi David Zlotnik, Encino, CA (US); James Mingjen Yang, Hacienda Heights, CA (US); Thomas Y. Chen, Pasadena, CA (US)

Correspondence Address: CONNOLLY BOVE LODGE & HUTZ LLP, P.O. BOX 2207, WILMINGTON, DE, 19899, US

(21) Appl. No.: 12/030,743

(22) Filed: Feb. 13, 2008

(51) Int. Cl. G06F 17/00

(52) U.S. Cl. 715/234; 707/100; 707/E17.005

(57) ABSTRACT

A content collection and distribution system operates to collect digital data from a client node, and automatically distributes the collected data to predetermined destinations according to parameters designated in advance by authorized clients and/or other users. A mobile application is configured to operate on mobile handsets of a wireless telephone network, which comprise client nodes. A host curator application is configured to automatically classify incoming data from client nodes, re-formats the data as needed into the least common denominator format and pushes each data portion to a destination configured in advance for that data. A distribution host for data reception applets may be provided; the applets are configured to receive data from the curator application and manage the data for user access in a defined environment.

### BACKGROUND

1. Field

The present disclosure relates to management of electronic content in a computer network system that includes portable wireless client nodes.

2. Description of Related Art

Consumers often use mobile devices, such as cellular telephones or hand-held organizers, to casually record content such as events and scenes that may be happened upon while the mobile device is carried with the user. For many users, such recorded content is merely stored in a memory of the mobile device and later accessed only with the user interface of the device. As such, the content cannot easily be shared, published, organized, or securely archived. Applications are known for mobile handsets and other clients to transmit data, such as digital photographs, video or text, to remote locations, including locations on other networks that interconnect with the wireless phone network. For example, content may be e-mailed to a designated address using present mobile devices in cooperation with a host. However, current applications require users to manually configure each transmission, which many users seldom take the time to do. Thus, much content of interest languishes on the mobile device and is eventually lost, as a matter of course. In addition, precious images, messages and videos stored only on mobile devices are all too easily lost through commonplace mishaps such as device malfunction, battery failure, or accidental loss of the mobile device itself.

On the host side, organization, management and republication of video, photographic, or audio content from mobile devices is also lacking. While applets for receiving data are known in other contexts, the prior art does not provide for automatic organization and distribution of data to such applets or other destinations. In addition, user interfaces for access to content collected from mobile nodes do not enable one to organize, select or view input from one or more nodes in an automatically ordered timeline, such as one ordered chronologically.

### SUMMARY

According to the detailed disclosure provided herein, a content collection and distribution computer system operates to collect digital content from a client node. The content may comprise electronic video, audio, audio-visual, photographic, text, or other data that is encoded by or present on a mobile device, such as a mobile cellular telephone, operating as the client node. The encoded electronic content may be transmitted via a cellular data network to a system host computer, optionally also passing through a computer network, for example, the Internet, en route to the host. The host system may automatically distribute the collected content to predetermined destinations according to parameters designated in advance by authorized clients and/or other users. The host system may also store the content and provide secured access to it via a host user interface application.

The system may comprise three principal components. First, a mobile application designed to operate on mobile handsets of a wireless telephone network. The mobile handsets and similar handheld wireless communication devices may comprise client nodes in wireless communication with a host computer through one or more wireless or wired networks. The mobile application receives data from a handset or other client memory, and may automatically or semi-automatically upload the data to the host together with applicable metadata. The mobile application may provide a user interface responsive to user input, such as via a keypad, touchscreen, or microphone, to transmit designated content on the mobile device to the host. In the alternative, or in addition, the mobile application may automatically transmit content stored on the mobile device to a pre-designated host address.

The system may further comprise a host-side curator application configured to automatically process incoming data from client nodes. The curator application may classify incoming content according to associated metadata and measurable data characteristics. The curator may further re-format the data as needed into a least common denominator format, and push each data portion to a destination configured in advance for that data. The curator application may recognize applicable destinations by processing data and metadata characteristics according to defined classification schemes. Electronic content from the mobile devices may comprise digital data of unrestricted types, and should contain data items that are associated with respective contextual dates, and optionally, times, event names, or locations. For example, mobile devices are commonly used to collect photographic data, video (audio-visual) data, audio data such as recorded speech, and text. A contextual date is metadata describing a date that has a meaningful relationship to the data item, for example, the date a photograph or video was taken, the date that text was written, or the date that an event described in text or other data began or ended. A host-side user interface may be provided to enable users of handsets and other client nodes to define or modify custom classification schemes. An administrator may define default or generally applicable schemes.

The system may further comprise a distribution host for data reception applets. The applets may be configured to receive data from the curator application and manage the data for user access in a defined environment. For example, a flash video or HTML applet may be distributed to be incorporated by users in their own remote content pages. This may permit users to easily publish content captured using a mobile communication device on a personal web page, blog page, or the like. Optionally, content associated with selected events may be reviewed by a human reviewer and selected for broader publication on any appropriate publishing media. For example, users' concert videos may be reviewed and noteworthy examples selected for publication in other venues.

One use of the present technology lies in simplifying the collection, organization and use of photographs, videos, and other electronic data captured using small portable devices, such as, for example, mobile phones equipped with cameras and microphones, such as may be capable of capturing still photographs, video segments, and audio segments. Using the technology described herein, a user may archive and share personal content with little or no additional effort, after setting up a destination for uploaded content. For example, a user may elect that all photographic and video content on her phone is to be automatically uploaded and archived to her personal site managed through the host application. The host may also provided a web page interface for viewing content stored at the personal site, which may optionally be customizable by the user. Using the web page, the user may access content uploaded and stored at her personal site using any suitable network connection and web browser.

Optionally, the content host may provide a network user interface, such as a web page, for navigating stored content from mobile devices according to a time, geographic or hybrid-based scheme, such as a timeline, map or calendar. The data may be sourced from multiple unrelated client nodes, such as independent users of hand-held mobile capture devices, collected by the curation system described above. The data from multiple unrelated nodes may be amalgamated into a single application for depiction or publication. An applicable set may comprise a managed set, such as a library, database, or other collection of data items. An applicable set may alternatively comprise an unmanaged set, such as search results returned by a search engine or all items indexed by a search engine at a particular moment of time. An interface application may use an index or database for each applicable set in which contextual dates (and optionally, times, event names, or locations) are maintained in association with data items in the set. The index or database may provide one or more contextual dates associated with each item in the applicable data set. The interface application may be configured to receive client queries for items in the applicable data set. In response to such queries, the interface application may identify at least a primary contextual date associated with each data item returned by the query, and organize the query results in chronological order, such as on a timeline. The timeline may be presented as a zoomable navigational tool for identifying dates or periods of interest, and data items associated with such dates or periods. The interface application may be especially useful for data in which contextual dates are assigned according to consistently applied criteria, such as photographs or video of events.

Thus, content collected by multiple client wireless devices may be automatically organized and distributed for user access. A more complete understanding of methods and systems for automatic content collection and organization from mobile devices will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 is a diagram showing an exemplary system for automatic content management, including collection and organization of content from mobile devices.

FIG. 2 is a process diagram showing an exemplary process for automatic content management, including collection and organization of content from mobile devices.

FIG. 3 is a development diagram showing exemplary components of a system for automatic content management.

FIG. 4 is a diagram showing a layered view of an exemplary system architecture.

FIGS. 5A-D are exemplary screenshots of a mobile device operating a client-side application for uploading content to a host.

FIG. 6A is a flowchart showing exemplary steps of a method for collecting electronic content from client wireless mobile clients.

FIG. 6B is a sequence diagram showing an exemplary runtime scenario of a system for collecting electronic content from client wireless mobile clients.

FIGS. 7A-C are exemplary screenshots of browser displays for accessing uploaded content.

FIG. 8A is a flowchart showing exemplary steps of a method for configuring presentation of electronic content from wireless mobile clients.

FIG. 8B is a sequence diagram showing an exemplary runtime scenario of a system for configuring presentation of electronic content from wireless mobile clients.

FIG. 9A shows exemplary steps of a method for managing and distributing uploaded media objects.

FIG. 9B is a sequence diagram showing an exemplary runtime scenario of a system for managing and distributing uploaded media objects.

### DETAILED DESCRIPTION

The detailed description that follows includes a disclosure of exemplary systems that may serve as a framework for collecting, managing and distributing content collected from wireless mobile client devices. Exemplary computer-implemented methods using features of the disclosed exemplary systems are also disclosed, together with exemplary use cases. In the figures and detailed description, like element numerals may be used to indicate like features appearing in one of more of the figures. Titles and subtitles used herein are merely exemplary, and do not limit any disclosures provided under them.

### System Overview

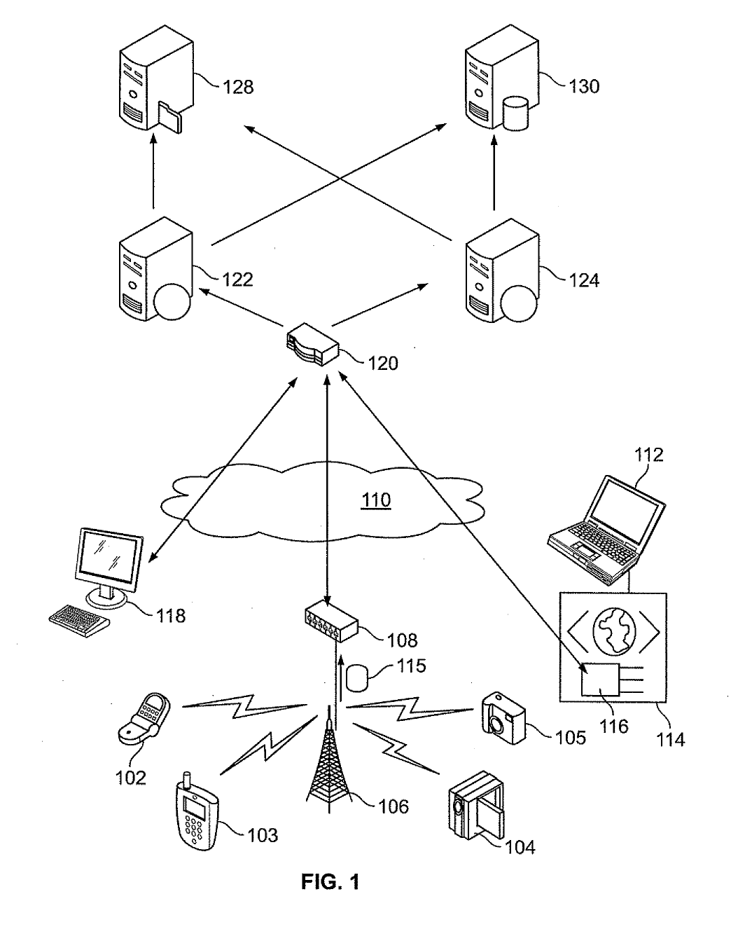

Referring to FIG. 1, exemplary system 100 includes node, components and communication pathways for collecting, managing and distributing content from an exemplary plurality of wireless client devices 102, 103, 104 and 105. Such devices may include one or more mobile telephones 102, such as a cellular telephone capable of sending and receiving voice and digital data transmission using one or more applicable protocols, for example, CDMA, GSM, TDMA, W-CDMA, or CDMA2000 EV-DO. Modern cellular phones are often equipped with a digital camera, microphone, processor, memory, and software or firmware for capturing, storing, editing, and wirelessly transmitting electronic content such as still images, video segments, text, or voice recordings. Other wireless client devices with a capacity for capturing, storing, editing, and wirelessly transmitting such data may include personal organizer/email devices 103, sometime called palmtop computing devices, more specialized portable digital cameras 105 or video cameras 104. Currently, the vast majority of or all client devices expected to be used at the collection end of system 100 comprise some sort of mobile telephone 102. However, the system may also be used with various other types of client devices for collection and uploading of video, still image, text and audio data.

A suitable application may be provided for each respective client device, configured to capture and upload content from the client to the host 122. Such application may provide for automatic addressing of uploaded content 115 to a designated host, so that the content will be uploaded to a designated address without a specific destination being designated by the end user. In addition, or in the alternative, uploading of content captured by the client may be performed automatically to the designated host, so that no user action is required to upload content apart from performing the data capture.

Client devices 102-105 may transmit and receive data via one or more nodes 106 of a wireless network. While only one wireless node 106 is depicted for illustrative simplicity, it should be appreciated that numerous different nodes and associated networks may be used to communicate to client devices participating in the system. The system is not limited to a particular wireless network or node. Likewise various wireless networks may be connected to a wide area network 110, such as the Internet, using a respective hub 108. Again, although only one hub is shown in FIG. 1, it should be appreciated that any non-zero number of hub nodes adapted to connect a wireless network to a WAN 110 may be used.

Other exemplary nodes may include a web host 112 hosting a web site comprising various web pages, including content page 114. The content page 114 includes an embedded interactive application 116 for presenting electronic content 115 collected by the wireless mobile client devices. The electronic content 115 may comprise media objects such as JPEG still image files, MPEG audio-visual clips, text, or recorded images, video, or speech in any suitable format. The embedded application 116 may be sometime referred to as a widget, and may be implanted as an embedded Flash™ client. The application 116 may be configured to receive an RSS data feed supplying the collected electronic content 115 or an address for it. A client 118 may comprise a web browser capable of viewing the content page 114 and any electronic content 115 presented by widget 116. For example, a video recorded using a mobile phone 102 may be viewed on an electronic display of client 118 via operation of the widget 116 embedded in content page 114.

Widget 116 may be used primarily for presentation of content uploaded from the plurality of client wireless devices to a host 122, and downloaded or streamed from the host to any network client running the widget, e.g., client 112 or 118. However, the widget is not limited to presentation of content from wireless mobile devices, and may be used to present any designated content set. In addition, the widget may be configured to enable uploading of data, for example, video, images, speech, or text, from a client on which it is operating to the host. For example, clients 112 and 118 may perform functions that would otherwise be performed by servers 122 and 124. Host 122 or other system host may host content uploaded by the wireless client devices and optionally, content pages holding a widget or links to uploaded content. In the alternative, content pages may be independently hosted. To provide for access to content 115 through an independently hosted page, the author or administrator of the content page need only paste a configured widget into the applicable page. A configuration function hosted by host 122 may provide configured widgets for posting.

A widget 116 may provide a configurable interface for presenting a library of uploaded content from each user account, or from designated users. The widget may include conventional or novel interfaces for organizing and selecting content to be reviewed. The widget should have the capability to display image files, and to play video, audio, and audio-video files. A widget may be implemented as a plug-in for an HTML web page. For example, the sample code below exemplifies an HTML widget utilizing a content player from www.mixercast.com:

<div style=“height:126px; text-align: left”>
<embed src=“http://www.mixercast.com/getPlayer/id/MzA5MzUw”
allowFullScreen=“true”
quality=“high”
pluginspage=“http://www.macromedia.com/go/getflashplayer”
type=“application/x-shockwave-flash”
bgColor=“#000000”
BASE=“http://asset.mixercast.com/share/resources/modules/blogifiedz/
editor/bree/” width=“734” height=“126” >
</embed></div><div><div><ul style=“float: left; padding: 0; margin: 0;
list-style: none; width: 734px; text-align: center; background: url(http://
bitcast-a.bitgravity.com/nanocast/i/layoutGrey/buttons/nugget/
btn_Remix.gif)
repeat-x; border-top: 1px solid #4b4948; border-bottom: 1px solid
#4b4948;”>
<li style=“float: left; width: 30%; background: url(http://bitcast-
a.bitgravity.com/nanocast/i/layoutGrey/buttons/nugget/btn_Remix.gif)
repeat-x;”>
<div style=“background: url(http://bitcast-a.bitgravity.com/
nanocast/i/layoutGrey/buttons/nugget/btn_MixerCasttxt.gif) no-repeat
center; margin: 0 auto; width: 157px; height: 24px ”>
<a href=“http://www.mixercast.com/_mixercastView.jsp?blogifiedId
=MzA5MzUw” target=“_blank” title=“MixerCast”
style=“text-decoration: none”>
<span style=“visibility: hidden”>MixerCast</span></a></div></li>
<li style=“float: left; width: 49%; background: url(http://bitcast-
a.bitgravity.com/nanocast/i/layoutGrey/buttons/nugget/btn_Remix.gif)
repeat-x; border-right: 1px solid #4b4948; border-left: 1px solid
#4b4948”><div style=“background: url(http://bitcast-
a.bitgravity.com/nanocast/i/layoutGrey/buttons/nugget/
btn_MakeShowsLikeThistxt.gif)
no-repeat center; margin: 0 auto; width: 146px; height: 24px; ”>
<a href=“http://www.mixercast.com/_create.jsp” target=“_blank”
title=“Make Shows Like This” style=“text-decoration: none”>
<span style=“visibility: hidden”>Make Shows Like
This</span></a></div></li>
<li style=“float: left; width: 20%; background: url(http://bitcast-
a.bitgravity.com/nanocast/i/layoutGrey/buttons/nugget/btn_Remix.gif)
repeat-x;”>
<a href=“http://www.mixercast.com/_mixercastView.jsp?blogifiedId
=MzA5MzUw&remix=true” target=“_blank” style=“width: 35px;”>
<div style=“background: url(http://bitcast-
a.bitgravity.com/nanocast/i/layoutGrey/buttons/nugget/btn_Remixtxt.gif)
no-repeat center; margin: 0 auto; width: 35px; height: 24px ”>
<a href=“http://www.mixercast.com/_mixercastView.jsp?blogifiedId
=MzA5MzUw&remix=true” target=“_blank” title=“Remix” style=“text-
decoration: none”>
<span style=“visibility:
hidden”>Remix</span></a></div></a></li></ul></div></div>

Client 118, wireless bus 108 and widget 116 may communicate with host-side servers via any suitable communication mode, such as using HTTP communications over WAN 110 or TCP tunneling. Communications may be directed via one or more webhosting routers 120 directing HTTP traffic to a primary web hosting server 122 and a backup server 124. File serving, including but not limited to providing electronic media objects (i.e. content) in response to client requests, may be implemented via NTFS implemented in a file server 128, or other suitable file system. Management of client data and metadata may be handled via Java Database Connectivity (JDBC) or other suitable connectivity to an SQL database server 130. Backup server 124 may mirror the primary server and take over primary operation in the event of a failure at the primary web server 122. It should be appreciated that other server systems may function to perform the operations described herein, and the technology is not limited to the particular illustrated system.

System 100 may be configured such that mobile clients may configure a data feed to a designated destination, such as to the embedded widget 116, via a web page interface available through server 122 or other host. Such a configuration page may be used by a client to configure an XML feed accessible by HTTP, which may be similar to a RSS feed, describing the electronic content to embed inside the widget 116. For example, an XML feed such as the following may be configured:

<?xml version=“1.0” ?>
<rss version=“2.0”>
<channel>
<title>Volcano erupting</title>
<description>3gp</description>
<link>rtsp://gotvnetworks.com/zz123/coachella/redhot.3gp</link>
</channel>
<channel>
<title>Shark Picture</title>
<description>jpg</description>
<link>http://gotvnetworks.com/zz123/ciacgekka/paul.jpg</link>
</channel>
</rss>

This XML feed may be dynamic, meaning it may be automatically updated once a user uploads new pictures and content. Thus, the widget to which it is directed will automatically include updated content. Host 122 may further provide in the configuration page the ability for a user to remove content from a designated data feed, to edit stored content, to delete the content entirely from the host's file storage system, or perform other data management.

### Exemplary Use Case

In the following exemplary use case, the following actors are used to demonstrate an exemplary use of system 100.

Human Actors
Patrick—Coachella concert attendee with a cell phone
Laurie—Patrick's friend stuck at work
Ken—Content Producer

Non-Human Actors
GoTV® Mobile Client—Cellphone based program that can capture video and pictures and upload to a server.
GoTV Website—User website that allows a user to create an embedded channel and configure it
Embedded channel—Flash widget that displays pictures and videos from a user
GoTV Server—Backend Server that handles uploads from a mobile device and creates a XML feed
Channel Server—Parses the XML feed and provides data for the embedded channel

I. Patrick at Home Before the Start of the Coachella Concert

Patrick is preparing for his concert at Coachella. Patrick wants to share pictures and videos with his friends on his MySpace® page while he is on the trip. Patrick logins into the GoTV Website and chooses to create a new embedded channel. He enters the GoTV New Channel page form. He creates a new embedded channel by entering in the title. Patrick then adds a mobile media capture widget and configures it to display all pictures and videos captured on the 1st day of the concert. Patrick also decides to add another mobile media capture widget that will display pictures from Day 2.

Once completed, Patrick clicks on save, and an embed code is displayed. Patrick then chooses use this embed code to update his profile on MySpace. Patrick's MySpace profile now displays the new embedded channel that shows “I'm with the band, Pictures and Videos coming soon.”

II. Patrick at Coachella Day 1

Patrick arrives at Coachella. At the concert, Patrick uses the GOTV Mobile client to capture a video of the band “Red Hot Chili Peppers” performing his favorite song. Patrick sneaks backstage, and takes pictures of the band “Rage against the Machine” and Paul van Dyk. Afterwards, during a break in the concert, Patrick uses the GoTV Mobile client to share his new videos and pictures. Patrick marks his favorite pictures and videos and the GoTV Mobile client sends the chosen pictures and videos to the GoTV Server. Patrick turns off his mobile phone. The GoTV Server then updates a XML feed with the newly shared pictures. This XML feed will be used later by the Channel Server.

III. Laurie Stuck at Work during Coachella Day 1

Laurie is nearing the end of her workday. She decides to kill some time by logging into MySpace. She knows that Patrick is at Coachella, and decides to view his MySpace profile.

Patrick's profile displays the embedded channel. While the embedded channel is loading, it connects to the Channel Server which parses the data feed from the GoTV Server. The embedded channel populates the “I'm with the band” Day 1 widget with the media items described in the XML feed. “I'm with the band” Day 2 still displays “Pictures and Videos coming soon.”

The embedded channel finishes loading and Laurie sees the videos and pictures of Day 1. She sees the videos and pictures of the Red Hot Chili Peppers, the pictures Rage against the Machine, and Paul Van Dyk.

IV. Coachella Day 1—Ken Content Producer in Hollywood

Ken, an editor and producer for GoTV, wants to create a slideshow of the Coachella concert. GoTV reporters were sent to the Coachella concert, however he is still missing pictures of Paul Van Dyk. Ken logs into the GoTV website, and views all the footage generated by GoTV users for the Coachella concert. He notices that Patrick's pictures and videos titled “I'm with the band—Day 1” are quite good. He finds pictures of Paul Van Dyk. Ken launches the embedded channel designer operable with the Channel Server and quickly integrates the GoTV videos from his own reporters and Patrick's pictures. He saves the new embedded slide show and uses the generated embed code to update the GoTV and Hip Hop Official websites. Patrick's pictures are thereby made available to the public as mobile channel or website content.

### Exemplary System Configuration

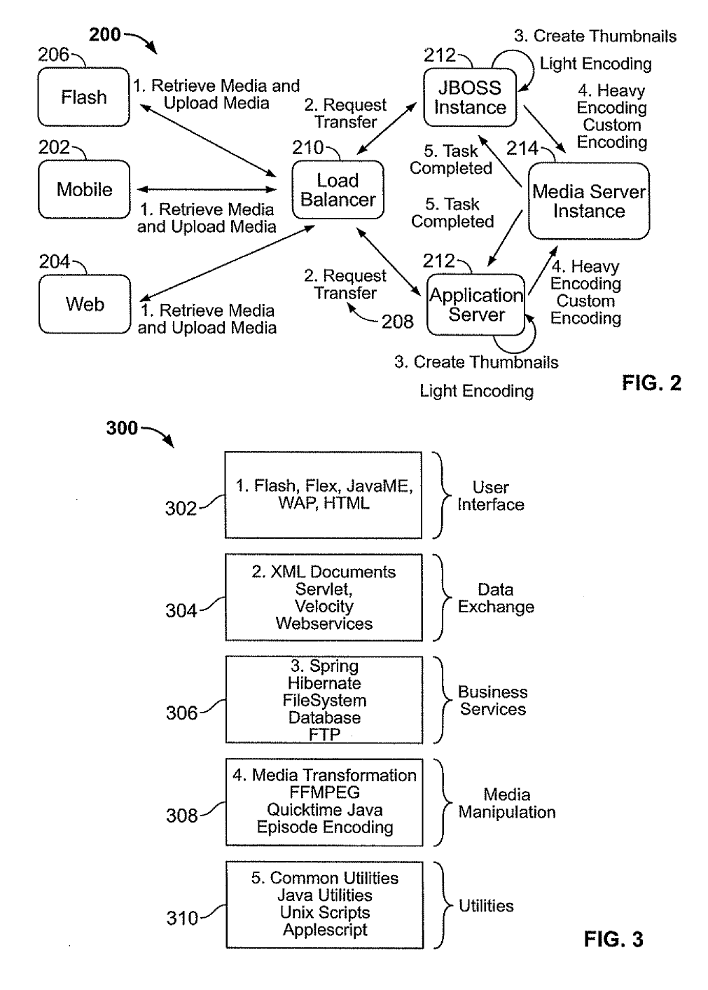

FIG. 2 shows an exemplary computer-implemented process 200 for automatic content management, including collection and organization of content from mobile devices 202. Each of the enumerated processes illustrated in FIG. 2 may be handled by any non-zero number of servers or mobile devices. Mobile process 202 may comprise operation of mobile wireless clients in communication with a network web host, as previously described. Web process 204 may comprise operation of any suitable web clients, also in communication with the web host. Flash process 206 may comprise operation of embedded applications in web content pages in communication with the web host, as also previously described. Each of the foregoing processes may operate to exchange media content with a media hosting process 208 via a load balancing process 210.

A load balancing process 210 may operate to distribute media requests, including both upload and download requests, to an available instance 212 of an enterprise application programmed for handling transfer requests. Each instance may create and handle any minor media transformation. For example, the instances 214 may create thumbnail images representing media content items available for access, based on the content data, extract thumbnail images from videos, convert 3GP video to web quality flash video, or resize images. These operations as described hereing as “minor” or “light” because they require relatively insignificant CPU utilization and very little time, such as less than 1 second.

In comparison, a “major” or “heavy” media transformation may comprise, for example, a conversion of a 3GP video format file into a HD quality video stream for the web, modification of videos to insert custom trailers and introductions, and transformation of videos into a streamable format. Such types of transformations are typically slow and CPU intensive, using present technology.

Custom encoding may comprise a combination of a series of light and heavy duty media transformation tasks. For example, a video uploaded by a mobile handset may run through a series of light and heavy media transformation tasks in order to be viewable by flash, mobile, and web clients. Such tasks may involve, for example, thumbnail creation, transformation of 3GP video to flash video, and 3GP video to other mobile video format types.

Instance 212 may be deployed on a JBOSS Enterprise Application servers. Instance 212 may have responsiblities such as a host as a web application, messaging system, or batch process. Instance 212 should fulfill any media request or media upload distributed by the load balancing process 210. Application server 212 may also perform light media transformation tasks. Lastly, server 212 may batch up heavier media transformation tasks, such as tasks that take longer than 1 second and high CPU utilization, to a media server instance. In an open source environment, the request handling instances may be implemented using suitable open source software for building, deploying, integrating, orchestrating, and presenting web applications and services in a service-oriented architecture, for example, JBOSS™ Enterprise Middleware.

The request handing instances 212 may communicate with one or more media server instances 214 to configure media requests. Media serving process 214 may perform heavy media processing such as 3gp transcoding. The media serving process may queue heavy media processes using messages sent from the intermediate instances 212. Once the media server has completed the heavy media processing job, notification may be sent to the server process 212. A media server instance may be an asynchronous batch-job handler that handles heavy duty media transformation tasks. It may be implemented, for example, as a customized Linux server with a FFMPEG(opensource media transformation utility) or Apple X-Server running Episode(Commerical video encoder software) and Quicktime. The media server instance may have the following responsibilities 1) handle tasks batched up by the JBOSS Application Server 2) Complete any heavy media transformation tasks 3) Inform 212 through asynchrous messaging that the media transformation task is completed. Together, the intermediate processes 212 and media server instance 214 may provide media content in a suitable format for the destination device. Media content may be converted to a least-common-denominator format or to a specific format required by a requesting destination device.

FIG. 3 shows exemplary components 300 of a system for automatic content management, organized by function, in a development view. It should be apparent that the present technology is not limited to the depicted selection of components, which merely exemplify appropriate selections and illustrate an effective implementation of the systems and methods disclosed herein, generally employing open-source tools where possible. User interface functions 302 may be implemented using any suitable combination of Flash™, Adobe Flex™, JavaME™, WAP and HTML coding. User interface functions are implemented on mobile and web clients, and are user-specific.

Data exchange functions 304 may be implemented using XML documents, Apache Velocity™ templating engine to reference objects defined in Java code, Java Servlet™ technology for extending the functionality of a Web server and for accessing existing business systems, and Java Webservices™, which are web-based applications that use open, XML-based standards and transport protocols to exchange data with clients. Data exchange functions are also implemented on mobile and web clients, and are user-specific.

User data retrieval and storage functions 306 may be implemented using the Spring™ framework and other tools. Spring here refers to a Java/J2EE application framework built on a lightweight Inversion-of-Control (IoC) container well-known for its data access and transaction management capabilities. Object-relational mapping may be performed using Hibernate™, which is a full-featured, open source OR mapping framework for the Java platform. A file system may be used to store media items such as video, pictures, and sound. Java Database Connectivity (JDBC) may be used for implementing database queries. FTP may be used for file transfer. User data retrieval and storage functions may be implemented on server infrastructure, and be user-specific.

Media manipulation functions 308, including file transformations, may be implemented using media transformation tools such as in-house media code manipulation libraries, audio processing tools, and external images utilities. FFmpeg (http://ffmpeg.mplayerhq.hu/) is a collection of free and open source software libraries that may be used to record, convert and stream digital audio and video in numerous formats. Quicktime™ for Java may also be used for file export to alternative formats Quicktime has an application programming interface (API) for manipulating images and video which may be useful for this function. Episode® encoding is a media encoding application for the Mac and may be used for content repurposing and distribution for Web, DVD, mobile phones and portable devices. User data retrieval and storage functions may be implemented on server infrastructure, and are not user-specific.

Basic functions 310 support general operation of server infrastructure, and are not user-specific. Exemplary basic functions may include, for example, Apache webservices Common Utilities, such as file manipulation, character manipulation, text parsing, and debug logging, and Java Utilities for internationalization, URL manipulation, email utilities, and user input validation. Scripting may be performed by Unix Scripts and AppleScript. The foregoing implementation is, of course, merely exemplary. One or ordinary skill may implement the inventive concepts disclosed herein in a variety of ways.

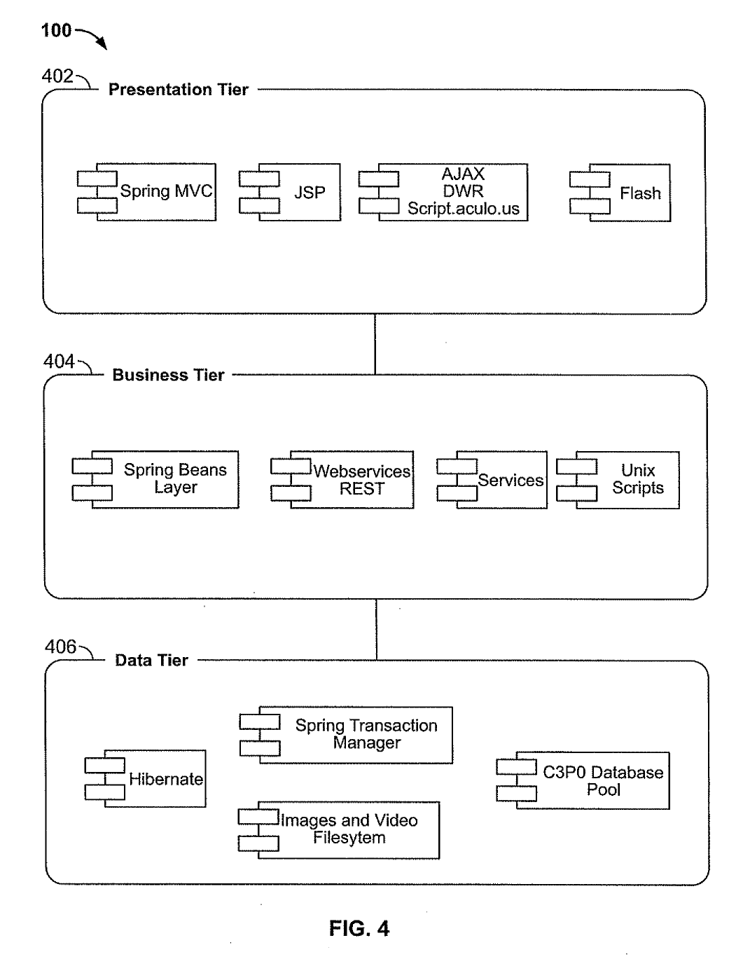

FIG. 4 shows a logical view of a layered architecture for a system consistent with the foregoing description. A presentation layer 402 handles presentation of content, command interfaces and advertising to end users. A Spring™ model view controller (MVC) may help separate presentation logic from business logic and ultimately to create the presentation that is returned to the user. JavaServer Pages™ (JSP) may be used to develop and maintain information-rich, dynamic Web pages that leverage existing business systems. Asynchronous JavaScript and XML (AJAX) Direct Web Remoting (DWR) with Javascript libraries available at http://script.aculo.us/ may be used for developing interactive web applications. As previously described, embedded interactive widgets may be coded using Flash™.

A business layer 404 handles business requests and services. As previously described, data handling may be performed using a Spring™ container. More specifically, a set of beans known as Spring beans may be configured and maintained. REST Web services, Java Servlets, and Unix scripts may further be applied. REST is an acronym standing for Representational State Transfer, and is an architectural style for development of web services, not a standard. REST is further described by Fielding, Roy Thomas in “Architectural Styles and the Design of Network-based Software Architectures,” 2000 (http://www.ics.uci.edu/˜fielding/pubs/dissertation//rest_arch_style.htm). A data layer 406 may handle storage and conversion of content data (e.g., video, audio and still images uploaded from client mobile devices). As previously described, Hibernate™ may be used to perform object-relational mapping. Spring™ may be used to provide a lightweight transaction infrastructure to manage component-level transaction assembling. Advantageously, Spring does not require, but is compatible with, J2EE container services like the JNDI DataSource. Another advantage is that the Spring lightweight transaction infrastructure uses an Aspect-Oriented Programming (AOP) enabled Spring bean factory. JDBC connection pooling may be implemented c3po™, which is a library for augmenting traditional (DriverManager-based) JDBC drivers with JNDI-bindable data sources, including data sources that implement Connection and Statement Pooling, as described by the jdbc3 spec and jdbc2 std extension. Images and videos may be stored in a file system.

### Mobile Client Application

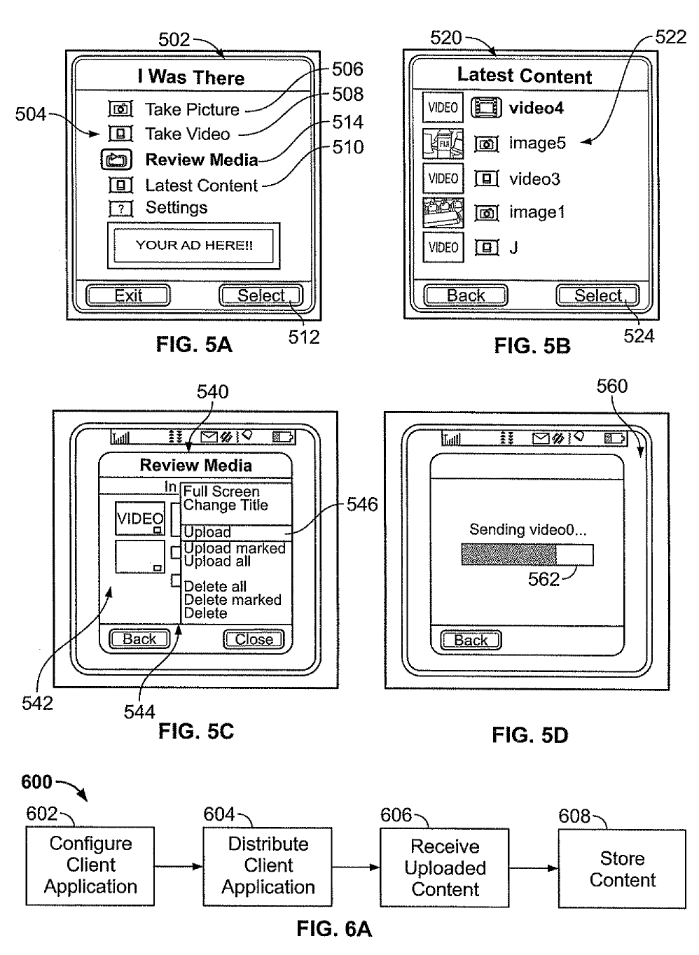

Consistent with the foregoing, one or more wireless mobile client devices may be provided with an application for capturing, viewing, editing, labeling and uploading content to a system host. Such client devices should be equipped with an integrated display screen or other interface operable to view content and provide command menus. FIGS. 5A-D show exemplary screenshots of a small portable display for a mobile client, to illustrate use and functioning of a client application for uploading of content.

FIG. 5A shows an exemplary screenshot 502 of a top-level command menu 504 for capturing electronic content and reviewing captured content. This top-level menu may appear when running the media application on the client device. Options on menu 504 may include take a picture 506, take a video 508, new content 510 and review media 514. The client device may be configured so that keypad presses or touchscreen input causes the application to move a selection cursor over the commands. When a command is highlighted, a user may choose a selection command button, causing the application to perform the selected function. When the take a picture command 506 or take a video command 508 is selected, the application communicates with a digital camera incorporated into the device to capture and record a still or video image. The application may timestamp such images and videos with a capture time, using a system clock. Optionally, a capture location may also be recorded, using a connected GPS locator or other location information. The application may also permit a user of the device to enter and attach descriptive metadata to captured content in the form of text or audio notes.

In the exemplary screenshot, selection of the new content command 510 may cause the application to generate a media gallery screen 520, as shown in FIG. 5B. The media gallery screen may display a list 522 of new content stored on the client device, optionally with a descriptive thumbnail image. The application may be configured such that a user may highlight any item in the list and activate the select button to view, edit, or perform an upload operation on the selected new content.

Likewise, selection of the review media command item 514 from the top-level menu 504 may cause the application to display a review media screen 540, as shown in FIG. 5C. The review media function may enable a user to scroll through all content on the client device and select any item of content for viewing, editing, deleting or uploading. Whether selected off of a new content list 522, an all content list 542, or by any other method, once an item of content has been selected, the client application may provide a simple command access for uploading the content to a designated host. For example, screenshot 540 shows a pop-up command menu 544 that includes an upload command 546. By highlighting and selecting the upload command 546, the user may cause a currently selected content item and its associated metadata to be uploaded to a predefined host. As indicated on the pop-up menu 544, the user may similarly select and upload certain marked content items or all items that have not previously been uploaded.

Whatever the details of the client application's operation, it should be configured so as to facilitate the selection and uploading of content items in a streamlined fashion. In the illustrated example, selection of an “upload” command for one or more selected content items causes the item or items to be uploaded to a designated host. In the alternative, or in addition, the client application may automatically select content for uploading. For example, the client application may be configured so that all content captured using the application is automatically uploaded to the designated host some time after capture, such as, for example, ten minutes after capture. This permits a user to delete items that she does not wish to have uploaded, and all non-deleted items after the lag period will be uploaded. The application may automatically perform the uploading operation, optionally displaying a progress screen 560 with a progress bar 562 as shown in FIG. 5D, reporting on the upload status. In addition, or in the alternative, uploading may be performed automatically in the background, as network resources permit, without display of a progress screen. The designated host may be defined before the application is installed on the client device. Thus, the user of the client device never has to concern herself with designating an address or recipient for the uploaded content, although she may be permitted to designate another recipient, if desired.

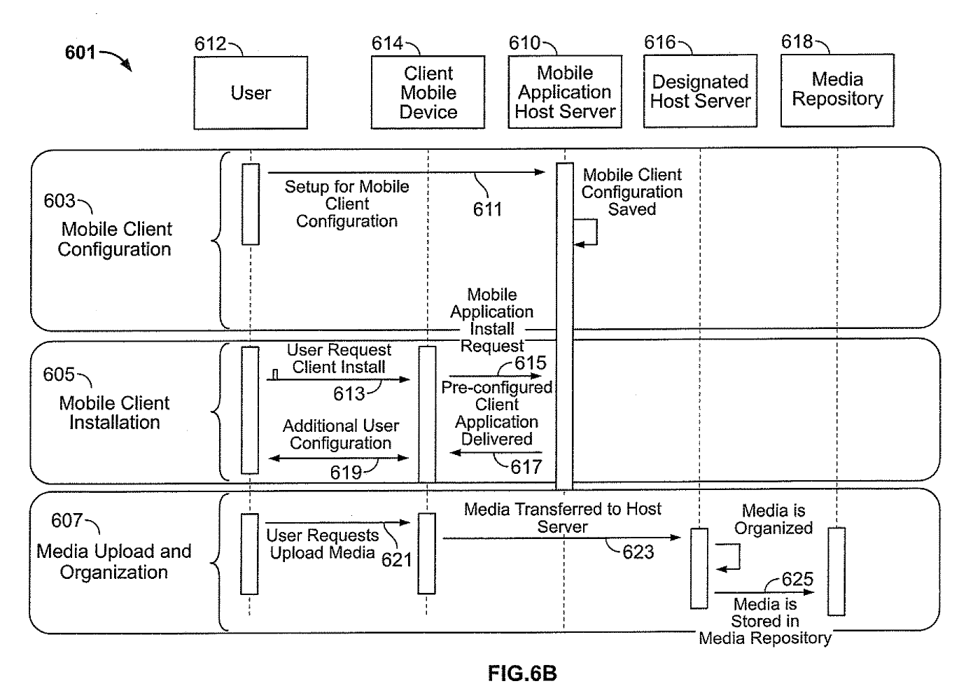

With respect to the foregoing, the disclosed mobile client application is used in a computer-implemented method 600 for collecting electronic content from client wireless mobile clients, as shown in FIG. 6A. Method 600 may include a step 602 of configuring a mobile client application to capture electronic content using a capture device of a client mobile device, to time stamp the electronic content with a capture time, and to upload the electronic content and timestamp to an automatically designated host. This step may be performed by configuring a mobile client application to operate in the described fashion, prior to distribution from a host. In addition, the mobile client may be configured to automatically mark each item of electronic content with an indication of geographic location where the item is first recorded by the wireless mobile client. The mobile client application may be further configured to operate in any suitable fashion as described herein, for example, to upload content to the designated host after a time lag, without requiring the user to initiate the upload.

At step 604, the mobile client application may be distributed for installation on a plurality of wireless mobile clients. This may be accomplished in a pull mode using an operating system and interface of the mobile client. Such clients often permit subscribers to select and download applications for installing on the mobile client. The mobile client described herein may be offered as one such available application to interested subscribers. In addition, or in the alternative, the mobile client application may be installed prior to initial delivery of the mobile device to the end user. Configuration of the client mobile application may continue after installation via an automatic update procedure.

At step 606, the designated host may receive electronic content uploaded from various wireless mobile clients in response to upload commands or via automatic uploading. Various communication protocols may be used for uploading content, including but not limited to electronic mail and FTP. Whatever protocol is used, each mobile application designates the destination, content, host, and protocol. The host receives and processes uploaded content. The designation of the host may be defined in advance at each mobile device without participation by the users of the mobile devices that are uploading the content, via configuration of the client mobile application. In other respects the mobile devices may retain their capability to send content to designated addresses, such as using electronic mail.

At step 608, the host stores the electronic content and any associated metadata to be used in organizing stored data for later presentation. Organization and use of uploaded data is described elsewhere in this specification. The foregoing steps may be encoded as executable instructions in a computer-readable media, for example, in a hard drive used by host 122 of FIG. 1, or in a portable media, such as an optical disk, electronic memory device, or magnetic tape or disk.

FIG. 6B is a sequence diagram showing an exemplary runtime scenario 601, which may be applicable for method 600. Various other scenarios may also be possible. Mobile application configuration 603 may be performed by a mobile application host server 610 in response to a setup request message 611 from user 612, such as, for example, via a user interface web page or pages served from the host 610 to any suitable client operated by user 612. Configuration may comprise an interactive, iterative process between the user 612 and host 610. It may be performed at times selected by the user; for example, a user may decide to change an already established configuration at any time after it is established.

Installation 605 may involve interaction between the user 612, client mobile device 614 and mobile application server 610. Installation may be initiated by user input 613 requesting installation, such as via an interface for a administrative application configured to generally manage installation of third-party applications on the mobile device. Such an application operating on the mobile device 614 may, in response to the user input 613, generate and transmit an installation request 615 to the host 610. Such a request may include, for example, user account information for billing purposes, and device configuration information to confirm or enable system compatibility for the application to be installed. Host 610 may communicate user account data to a billing server (not shown), and/or may store account and configuration data in a database for future reference.

In response to installation request 615, mobile application host 610 may transmit 617 an executable copy of the application to the client device 614. The client device may then install the downloaded application, and interaction 619 may occur between user 612 and device 614 for further configuration of the downloaded application. The mobile application may operate in the background of the mobile client memory until called upon to be configured, to upload content to a content host, or otherwise manage content on the mobile device. In the alternative, or in addition, the mobile client may be called and loaded by a different application or system, such as a client device operating system, in response to predetermined user input.

Media upload and organization may be initiated by a user request 621 directed to the mobile device 614. For example, using a keypad the user may select one or more media files residing in a non-volatile memory of the client device, and issue an upload command. While the mobile device may allow the user to specify a specific destination for each file to be uploaded, the absence of a specified destination may conveniently be interpreted as a designation of a default destination. The mobile application may receive the client request and transfer the selected files 623 to the default host server 616 designated for receiving content from the particular client device or associated user account. Hosts 610, 616 may reside on the same physical computer, or may be distributed among any number of different machines.

The designated host 616 may organize received content according to any metadata that is associated with media objects within it, and according to any predefined rules for organizing uploaded content as defined by a system administrator, end user, or a combination of system and end user defined rules. To organize in this context means to assign the object to one or more data classes in accordance with a defined organizational scheme. Assigned classifications may be recorded in object metadata, in a separate database, index, or any combination of the foregoing. The designated host server may transmit 625 content to a media repository 618, which stores the content until requested by a client node.

### Web Client

A system as described herein may include a web client application for configuring uploaded content and its use, most typically by the end user that contributes or otherwise had administrative authority over uploaded content. Uploaded content is received by the designated host and organized according to metadata associated with each item. Capture time may be used as key organizing information. Naturally, each content item may also be organized according to source, the source identity being either a client device identifier, user identity, or both. Other useful metadata for content organization may include a capture location, description (such as event or subject) of subject, metatag, data type, or data quality. The host may store the received content using the system and tools described above, in cooperation with a relational database using the selected metadata fields for organization. The collected content may reside in file storage, subject to storage limitations, until deleted by the contributing user.

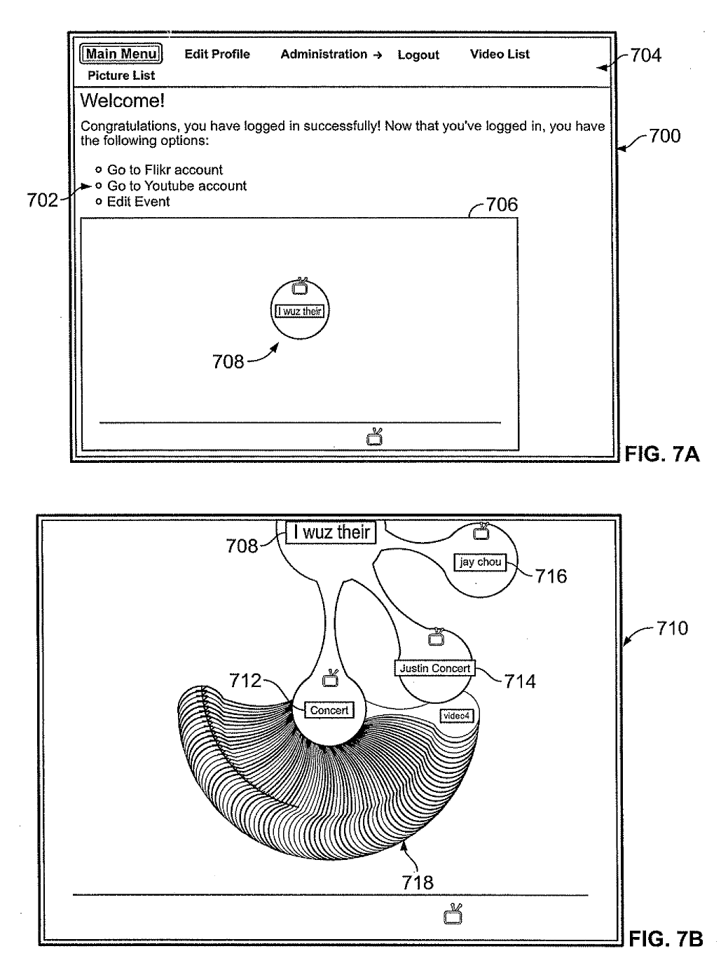

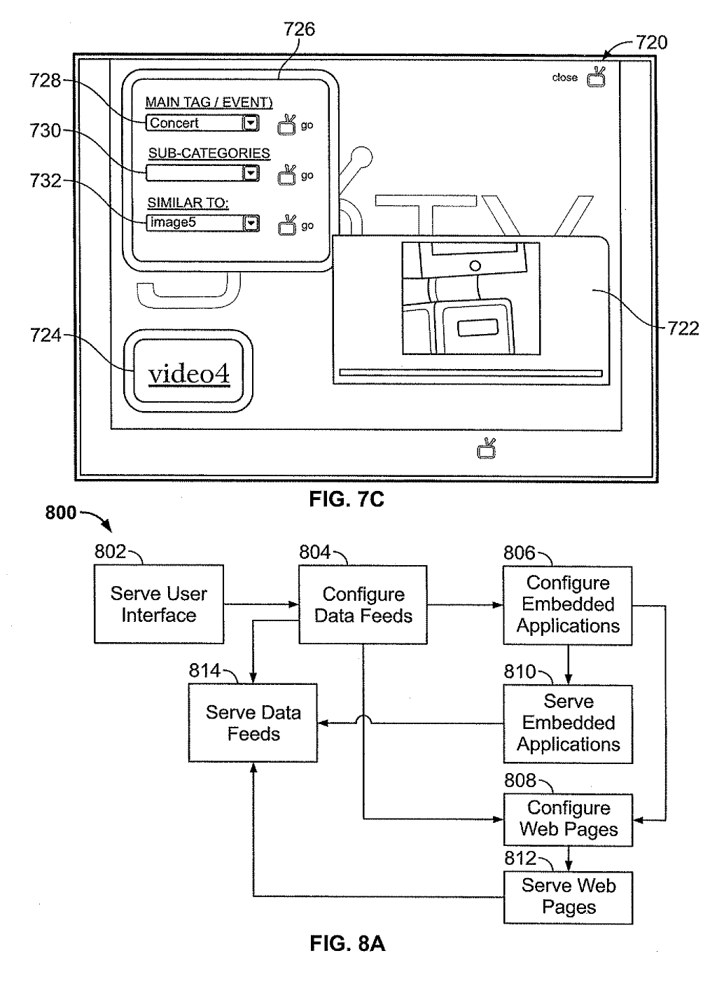

The web client may include functions for configuring storage, display, and further distribution of uploaded content, selecting uploaded content, editing, and viewing uploaded content. FIGS. 7A-C show exemplary screenshots of a web client for content management, use and display.

FIG. 7A shows an exemplary screenshot 700 of a main menu window 702 for a web client. Window 702 includes a menu bar 704 with options such as main menu, edit profile, logout, video list, and picture list. By selecting video list or picture list from the menu bar, a user may be present with a chronologically ordered list of videos or pictures stored by the host system for the benefit of the logged-in user. On the main menu, options include “go to Flikr account,” “go to YouTube account,” and “edit event.” The Main menu screen also includes a window 706 showing output from the user's configured embedded widget. In the exemplary depicted view, widget window 706 is showing a top-level content tab 708 indicating the presence of content under the label “I wuz there,” appearing as a circular icon in the middle of the widget display window. Appearance and operation of the embedded widget is limited by little other than the imagination of the designer. The widget window 706 may appear on any web page in which it is embedded, including user pages hosted by third party sites. System data feeds to the embedded widgets may be configured to operate independently of third party sites whenever and wherever an embedded widget is activated.

The web client may provide a link for configuration of the embedded widget, such as indicated by the command “edit event.” The depicted exemplary shot shows an event-based organizing template in which it is assumed that users will upload content associated with various events. Menus and commands accessible using “edit event” may therefore permit a user to define and organize labels, time periods, or other parameters for events by which uploaded content is to be organized. Although not depicted, other organizing principles may also be adopted, such as the identity of the subject matter depicted in uploaded content or the genre of the content. As in any relational database, content may be associated with more than one metadata field.

Other commands on the main menu may permit the user to directly access secondary destinations for uploaded content for which the user maintains a web presence. For example, the user may maintain a page on a third-party web site such as a Flikr page or YouTube page. The web client may permit the user to configure data feeds for these sites. In addition, the web client may provide a link to third-party accounts to which data feeds are provided, so users may configure placement of the embedded widget on the user's third party page.

FIG. 7B shows an exemplary view of the widget display window 710 after the user has interacted with the widget to drill down to a level of greater granularity. For example, the user may mouse-click on the top-level icon 708 to expand a file tree including branches 712, 714 and 716. Each of these branches is labeled with a descriptive label. By clicking on any icon representing a branch, the user may drill down to a level of still greater granularity. For example, by clicking on the icon 712 labeled “concert,” the user may cause the widget to reveal a plurality of branches 718. In the illustrated example, the plurality of branches are arranged in chronological order from left to right, in a fan arrangement. All are related to the “concert” label of the higher-level branch icon 712. As a user moves a pointer over the branches 718, each branch may be highlighted as it passes under the pointer and its label may appear, for example, “12/12/2007 9:05 pm.” In the alternative, or in addition, a thumbnail image of the content may appear on the screen while the pointer is over a node. The user may activate a “zoom” feature of the widget window to “zoom in” to see more detail of the file tree or “zoom out” to see less detail and a greater overview.

A file tree for uploaded content as exemplified in FIG. 7B may be configured as a wholly self-organizing feature, or partially self-organizing feature. When configured as a partially self-organizing feature, the user supplies one or more first parameters for organizing uploaded content, and the system automatically provides one or more second parameters for organizing content. The user may provide a label or other parameter for each item of uploaded content when uploading the content or when reviewing it at the web client. For example, the user may label a set of video clips or photographs with a label “Coachella Concert 2007,” “Baby Ann,” “Joe's B'day 2007,” and so forth. Similarly, the system may automatically provide a second parameter, such as a date and time the content item is recorded by the client mobile device. When the content is uploaded, a host application performs a function of organizing the content so that it will appear in a file tree with high-level nodes determined by user-supplied labels and lover-level nodes determined by a date or time of recording.

When configured as a wholly self-organizing feature, the system automatically provides all parameters used in organizing the content. Therefore, the user need only upload the content without bothering to supply a label or other classification parameter. For example, the client mobile device may associate a time and geographic location for each content item, from which the host system will infer an event for each item of uploaded content, for example, “Coachella Concert 2007.” The host may then organize content by event and date/time of recording. If content is uploaded for which the host system is unable to associate a known event, it may be saved in a “miscellaneous” file node and later classified by the user via the web client, if desired. In a more sophisticated system, the user may configure the system to perform tasks such as automatic facial recognition or automatic recognition of other features and use analysis results to classify uploaded content together with more easily determined parameters such as time or place of first capture. In some embodiments, time and/or place of capture may be used as the sole criteria for organizing uploaded content.

Lowest-level nodes of a file tree presented in a widget window such as window 710 may be linked to an item of uploaded content. By clicking on or otherwise activating a lowest-level node, a user may cause a content item window 720 to appear, as shown in FIG. 7C. The content item window may display the content item in a display window 722, which may function essentially as a media player. Item window 720 may also display an item label 724 which is a descriptive name for the item. By clicking on the item label, the widget may allow an authorized user to change the item name. Similarly, the content window may provide a parameter window 726 displaying classification parameters associated with the item, such as using drop-down lists 728, 730, 732. An authorized user may be enabled via window 726 to change the parameter by selecting new parameters from the drop-down lists, or by entering a new parameter to be included in the list.

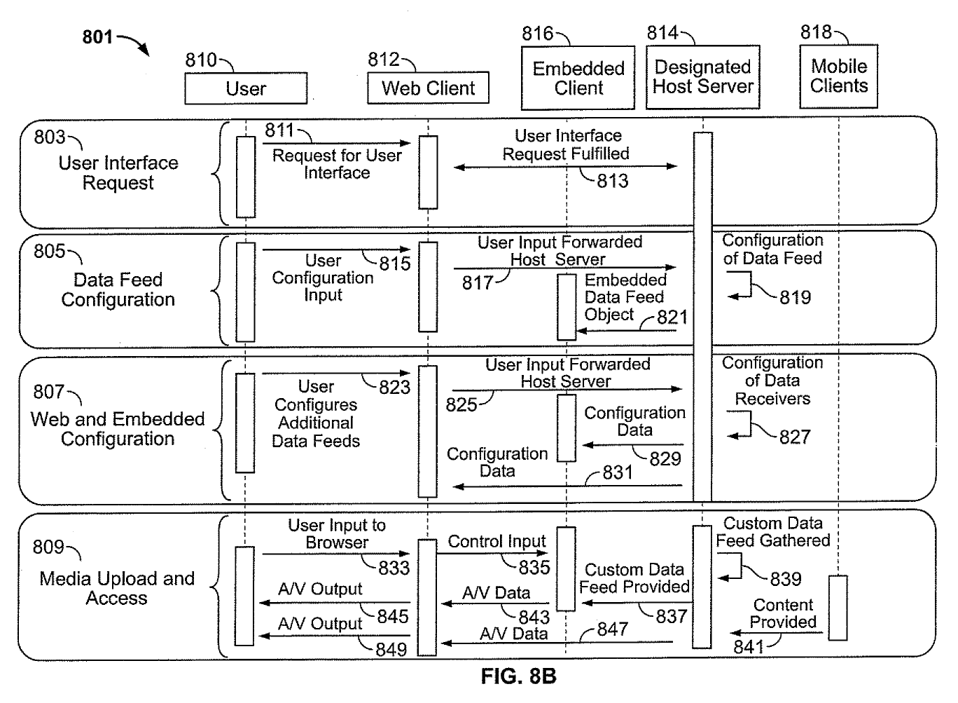

FIG. 8A shows exemplary steps of a method 800 for configuring presentation of electronic content from wireless mobile clients. Steps of method 800 may be performed by a web client hosted by a system host, or by the host. As such, the disclosed steps may be encoded in a computer-readable media, such as, for example, a magnetic disk or tape, optical disk or other media, or electronic memory device. At step 802, the host may serve a user interface operative to configure presentation of electronic content on Internet web pages in response to input from users of wireless mobile clients. For example, the host may serve the web client described herein in response to a user request.

At step 804, the host may configure data feeds in response to the user input. The data feed may comprise an XML feed as disclosed under “System Overview” above. The data feed may comprise an RSS feed. The data feed may be configured by the host in response to user input to cause embedded applications (e.g., widgets) in the Internet web pages to output the electronic content organized by associated time stamps associated with each item of electronic content. For example, as shown in FIG. 7B nodes of a file tree are arranged along a fan-shaped timeline, reflecting an underlying organization of the uploaded content in a system database.

Optionally, at step 806, the host may configure the embedded applications to receive the data feeds. As disclosed in the Exemplary Use Case above, a user may configure separate data feeds for separate widgets, which may co-exist on the same page.

Optionally, at step 808, the host may configure components of the Internet web pages distinct from the embedded applications, in response to the input from the users of the wireless mobile clients. This may be done in addition to configuring the data feeds. This option permits a user to configure one or more web pages that may contain direct links to uploaded content from the user. Such web pages may optionally contain an embedded interactive widget. For example, the main page 700 shown in FIG. 7A contains an embedded widget window 706. Page 700 also contains, via the menu bar, links to web pages directly containing uploaded content, such as a “video list” page and a “photos list” page. Such web pages may be secured as known in the art, such as by using account names and passwords, thereby limiting access to uploaded content to authorized persons.

Optionally, at step 810, the host may serve the embedded applications without the Internet web pages to a second host, configured for embedding by the second host in the Internet web pages. For example, the host may serve embedded widgets to a third-party site, such as the user's MySpace page. In the alternative, or in addition, the host may serve the Internet web pages itself, as shown at step 812. The second host and pages may be selected by the user to be secured, limited access pages or public pages, depend on the content to be accessed by particular embedded applications. Each user can determine which embedded applications will receive which content, and the web pages from which the content will be available, by configuring the embedded applications, data feeds, or by classifying uploaded content. Thus, each user may control the extent that particular content can be accessed, and by whom.

At step 814, the host may serve the RSS data feeds to the Internet web pages to cause the electronic content from the wireless mobile clients to be output from network clients, such as web clients. The network clients may be distinct from the plurality of wireless mobile clients. The electronic content may be output from the client as visual output from a display screen or as audible content from a speaker.

FIG. 8B is a sequence diagram showing an exemplary runtime scenario 801 which may be applicable for method 800. Various other scenarios may also be possible. To effect a user interface request 803 a user 810 may input a request for a user interface page 811 to a web client 812, such as, for example, by selecting a hyperlink to the interface page in an index web page being viewed by the user on the web client. The web client and a designated host server 814 may communicate 813 in a conventional manner to fulfill the user request. The selected interface may thus be displayed by the web client 812. Such a page may be configured to receive user inputs for configuration of a data feed, and provide information to the user to guide a configuration process.

To configure a data feed 805 the user 810 provides configuration input 815 to the web client 812. The web client 812 may forward the user input 817 to the designated host server 814, which configures a data feed, such as for a widget as described herein, in accordance with the user configuration input. The server 819 may then transmit 821 data feed configuration data to an embedded client 816, for example, a user-designated web page having an embedded widget for receiving the data feed.

To configure an embedded client 807 the user may provide additional configuration input 823 to the web client 812, specifying configuration of embeddable data receiver objects such as widgets or web pages for receiving data feeds. The web client may forward this configuration data 825 to the designated host server 814, which makes any necessary associations between the configuration of the data feed destinations and any existing data feeds and otherwise configure data receiving objects 827. Note that process 807 may be performed before process 805 and therefore there may not be any existing data feeds defined when the destination objects are configured. Configuration data may be passed 829 to the embedded client; this may include the embeddable data receiving object itself or data for configuring an existing object. Likewise, a new web page or data for configuring an existing page to receive a data feed may be passed 831 to the web client 812 which may forward the page to the appropriate host site for the web page. In the alternative, or in addition, the host server 814 may pass web pages directly to the host site, or host the designated pages itself.

A media access process 809, meaning user access to data feeds, may be initiated via a user input 833 to a local web client 812, causing a user request 835 to be transmitted to embedded client 816. In response, the embedded client may optionally transmit a data feed request to designated host (not shown). However, once the data feed is configured 805 the embedded client 814 will be supplied with the configured data feed 837. The configured (i.e., custom) data feed may be gathered and configured 839 by a designated host server 814 in response to upload of content 841 from mobile clients 818. The mobile clients may include the user's 810 own mobile client, and any clients belonging to the same public or private group as the user as determined during data feed configuration 805. The embedded object, in response to control input 835, may provide A/V data 843 to the user's web client 812, which in response generates A/V output 845 for user 810. In the alternative, or in addition, the server 814 may provide A/V data 847 directly to the web client or through an intermediate web host (not shown), which in response generates A/V output 849 for user 810. It should be appreciated that the A/V data and output may be in various forms such as video, audio/video, audio only, and text, or combinations thereof.

### Management and Distribution Method

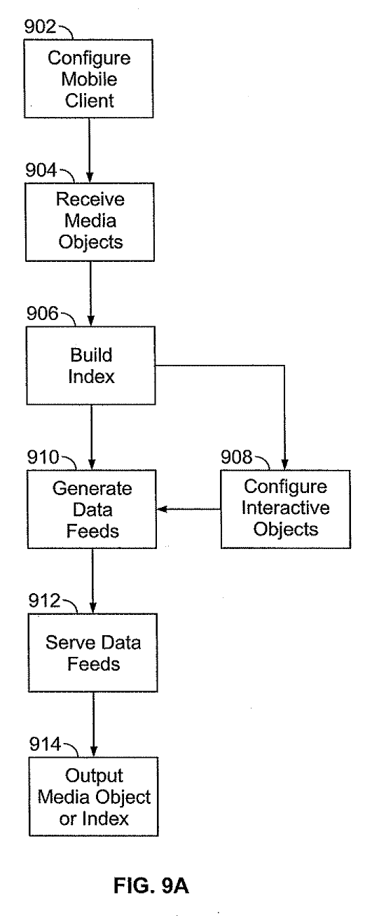

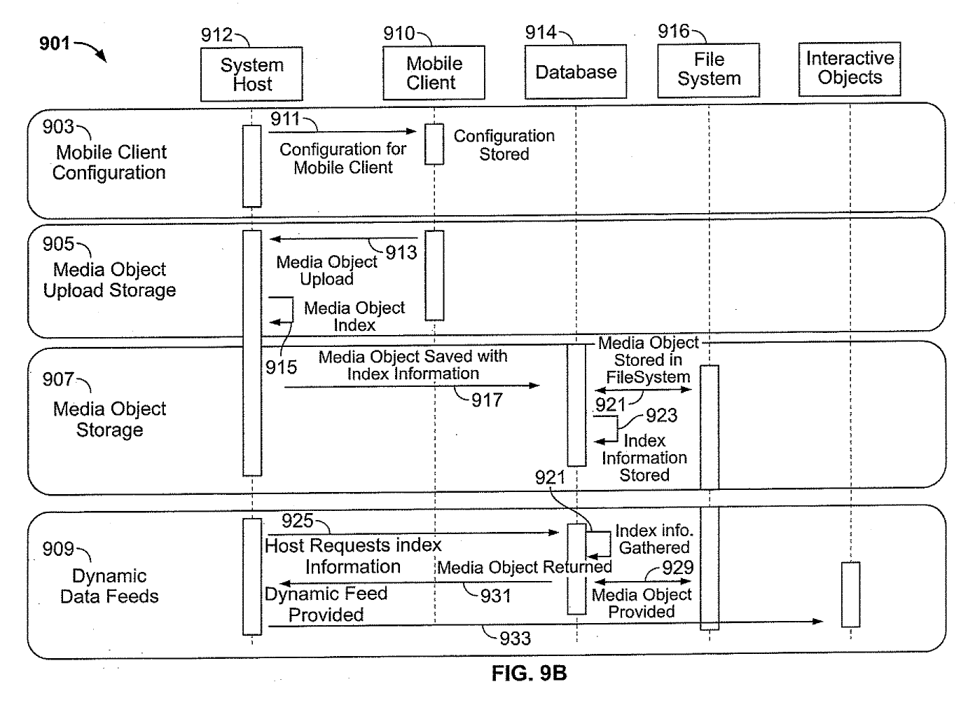

Consistent with the foregoing description, a method 900 as shown in FIG. 9 for managing and distributing electronic media objects may be performed using a system and components as described herein. Method 900 may be performed in addition to, independently of, or in conjunction with selected steps of methods 600 and 800 described above. Steps of method 900 may be performed by a system host, in cooperation with other system components. As such, the disclosed steps may be encoded in a computer-readable media, such as, for example, a magnetic disk or tape, optical disk or other media, or electronic memory device. Electronic media objects may include, for example, digital still images encoded in JPEG, TIFF, or other formats; digital video clips encoded in MPEG or other formats, audio files, text files, or other electronic content generated by users of mobile wireless devices.

At step 902, the host may configure a mobile client application to operate in a determined fashion, such as disclosed herein. For example, the mobile client application may be configured to automatically designate the host as a recipient of the electronic media objects collected by the client device on which it will operate. For further example, the mobile client application may be configured to automatically timestamp media objects with a date and time each media object is recorded by the client. The mobile client application may be configured to automatically location stamp media objects with a geographic location. The mobile client application may be configured to automatically upload media objects beginning at some defined period of time after each object is recorded, at periodic intervals, or at specific times of day. In the alternative, or in addition, the mobile client application may be configured to upload media objects in response to receiving a user-generated upload command.

At step 904, the system host may receive electronic media objects. Each object may originate from respective instances of the mobile client application distributed to the client mobile devices. The media objects may be pushed up by the client applications, or pulled up by the host. Media objects may be uploaded in response to user commands, or automatically according to predefined parameters.

At step 906, the system host may index the electronic media objects according to indexing data automatically provided by the respective instances of the mobile client applications. Indexing may comprise parsing metadata associated with each media object to identify indexing data defining parameters for indexing the object, and creating a database record for the object using the indexing data. The database record should contain or be linked to a stored instance of the object. The indexing data should indicate at least a respective time of recording and client identifier for each of the electronic media objects. Indexing data may further include an associated location, as may be automatically determined by the client device at the time of recording, or entered manually by a user. As described herein, indexing data may further include labels provided by the user or assigned by automatic recognition and characterization of images in the media objects.

Optionally, at step 908, the host may configure the interactive objects to display an index of selected electronic media objects when operating on the content pages. An exemplary index is shown in FIG. 7B in the form of the expandable file tree shown therein. An indexed display may take any other suitable form, for which a great variety of forms are possible. The display should indicate organization of the data according to the indexing data. For example, thumbnail images or other iconic links to uploaded media objects may be displayed along a timeline. In addition, or in the alternative, the interactive objects may be configured to display an index of selected electronic media objects in an ordered list. The interactive objects may be configured in response to client input. For example, using a client configuration interface, a user may designate classes of media objects to display using a particular widget, and the form of display.

At step 910, the host may generate dynamic data feeds each operative to configure a respective one of interactive objects for presenting the electronic media objects organized by associated portions of the indexing data. Each of the interactive objects may be embedded in a respective one of content pages, such as web pages. The data feed may comprise an XML feed, and RSS feed, or other suitable data feed. The data feed may be maintained in an updated but latent state on a host server until called by an active embedded interactive object. Data feeds need not comprise copies of electronic media objects, and may instead provide information by which current objects can be retrieved from the host file system.

At step 912, the host may serve the dynamic data feeds to the interactive objects. The data feeds may be served in response to calls from active ones of the interactive objects. An interactive object may be activated when a web page in which it is embedded is opened. In the alternative, or in addition, data feeds may be periodically pushed to predefined client destinations, or in response to updating of a data feed. Thus providing a current data feed causes a client output device to display or playback electronic media objects, and to display an ordered index of the objects 914. Meanwhile, the user that contributes each object need do little more than record the object using a mobile device, and optionally provide a metadata label or tag. The objects may thereby be safely archived, viewed and shared with unusual ease and efficiency.

FIG. 9B shows an exemplary runtime scenario 901 which may be applicable for method 900. Various other scenarios may also be possible. To effect configuration of a mobile client 910, system host 912 may transmit a configuration message 911 to the mobile client. The mobile client 910 may save the transmitted configuration in a local memory.

Conversely, uploading and storage of media objects captured using the mobile device may be accomplished by uploading the media object 913 to the system host. The system host may index the uploaded object 915, including assigning one or more appropriate classifications or other metadata according to a predetermined schema.

The server 912 may effect storage by transmitting the media object and index information 917 to a database 914. The database may store the object 921 in a file system 916, while storing the index information 923 locally.

A dynamic data feed may be generated by server 912 by requesting index information 925 for responsive to specified data feed parameters. For example, if a data feed is defined as “content contributed by user johnsmith8990 and tagged as ‘family’,” the server may periodically request media objects responsive to the feed parameters. The request 925 may be limited to media objects that have not already been provided in response to prior requests, or may pertain to all objects responsive to the specified criteria. In the alternative, or in addition, the request 925 may pertain to a specific media object requested from the server 912. In response to request 925, the database 914 may identify 927 index records responsive to the request. The database server 916 may obtain one or more media objects 929 identified using the index from the file system 916. The obtained media objects may then be provided to the system host 931. The system host may serve the media objects 933 to the defined interactive receiving objects 918.

### Conclusion

Having thus described a preferred embodiment of automatic content collection and organization from mobile devices, it should be apparent to those skilled in the art that certain advantages of the within system have been achieved. It should also be appreciated that various modifications, adaptations, and alternative embodiments thereof may be made without departing from the scope and spirit of the present technology. For example, a system for use with mobile wireless telephones having content collection features has been illustrated, but it should be apparent that the novel concepts described above may be applied by one of ordinary skill to other mobile collection devices and networks to thereby realize the unexpected benefits described herein.

What is claimed is:

1. A computer-implemented method for managing and distributing electronic media objects from a plurality of client mobile devices, comprising:
receiving electronic media objects at a host each originating from respective instances of a mobile client application distributed to client mobile devices;
indexing the electronic media objects according to indexing data automatically provided by the respective instances of the mobile client applications, the indexing data indicating at least a respective time of recording and client identifier for each of the electronic media objects;
generating dynamic data feeds each operative to configure a respective one of interactive objects configured for presenting the electronic media objects organized by associated portions of the indexing data, wherein each of the interactive objects is embedded in a respective one of content pages; and
serving the dynamic data feeds to the interactive objects.

2. The method of claim 1, further comprising serving a user interface operative to configure presentation of the electronic media objects in the content pages in response to user input from respective users of client mobile devices.

3. The method of claim 2, further comprising configuring the content pages in response to the user input.

4. The method of claim 2, further comprising configuring the interactive objects in response to the user input.

5. The method of claim 4, further comprising serving the interactive objects without the content pages to a second host, configured for embedding by the second host in the content pages.

6. The method of claim 1, further comprising serving the content pages.

7. The method of claim 6, further comprising serving the content pages being configured at least in part by respective users of client mobile devices.

8. The method of claim 6, further comprising serving the interactive objects with the content pages.

9. The method of claim 1, further comprising configuring the mobile client application to automatically designate the host as a recipient of the electronic media objects.

10. The method of claim 1, further comprising configuring the interactive objects to display an index of selected electronic media objects when operating on the content pages.

11. The method of claim 9, further comprising configuring the interactive objects to display an index of selected electronic media objects in an ordered list.

12. The method of claim 1, further comprising generating the dynamic data feeds as RSS feeds.

13. The method of claim 1, further comprising generating the dynamic data feeds as XML feeds.

14. The method of claim 1, further comprising storing the electronic media objects.

15. The method of claim 1, wherein the electronic media objects comprise audio-visual files.

16. The method of claim 1, wherein the electronic media objects comprise digital photographs.

17. The method of claim 1, wherein the interactive objects comprise embedded Flash clients.

18. The method of claim 1, wherein the client mobile devices comprise digital cameras.

19. The method of claim 18, wherein the client mobile devices further comprise cellular telephones.

20. A computer-implemented method for collecting electronic content from client wireless mobile clients, comprising:
configuring a mobile client application to capture electronic content using a capture device of a client mobile device, to time stamp the electronic content with a capture time, and to upload the electronic content and timestamp to an automatically designated host;
distributing the mobile client application for installation on a plurality of wireless mobile clients;
receiving the electronic content at the automatically designated host from the wireless mobile clients; and
storing the electronic content.

21. The method of claim 20, further comprising serving a user interface operative to configure presentation of the electronic content on content pages in response to input from users of the plurality of wireless mobile clients.

22. The method of claim 20, further comprising organizing the electronic content received by the designated host according to index data automatically provided by the mobile client application, the index data indicating at least a respective times of recording and client identifiers for the electronic content.

23. The method of claim 22, further comprising serving dynamic data feeds each operative to configure a respective one of distributable embedded applications configured for presenting the electronic content.

24. The method of claim 22, further comprising modifying the dynamic data feeds in response to receipt of new electronic content.

25. The method of claim 20, further comprising configuring the mobile client application to automatically mark each item of the electronic content with an indication of geographic location where the item is first recorded by one of the plurality of wireless mobile clients.

26. The method of claim 25, further comprising organizing the electronic content according to the indication of geographic location for each item of the electronic content.

27. A computer-implemented method for configuring presentation of electronic content from wireless mobile clients, comprising:
serving a user interface operative to configure presentation of electronic content on Internet web pages in response to input from users of a plurality of wireless mobile clients;
configuring data feeds in response to the input to cause embedded applications in the Internet web pages to output the electronic content organized by associated time stamps associated with each item of electronic content; and
serving the data feeds to the Internet web pages to cause the electronic content from the plurality of wireless mobile clients to be output from a plurality of network clients distinct from the plurality of wireless mobile clients.

28. The method of claim 27, further comprising configuring the embedded applications to receive the data feeds.

29. The method of claim 27, further comprising serving the embedded applications without the Internet web pages to a second host, configured for embedding by the second host in the Internet web pages.

30. The method of claim 27, further comprising serving the Internet web pages.

31. The method of claim 30, further comprising configuring components of the Internet web pages distinct from the embedded applications in response to the input from the users of the plurality of wireless mobile clients.

32. A computer-readable media for managing and distributing electronic media objects from a plurality of client mobile devices, the media encoded with instructions operative for:
processing electronic content items at a host as received from respective instances of a mobile client application distributed to client mobile devices;
indexing the content items according to at least respective times of recording and client identifiers for each of the electronic media objects;
generating dynamic data feeds each operative to configure a respective one of interactive objects configured for presenting the content items organized by respective times of recording, wherein each of the interactive objects is embedded in a respective one of web pages; and
serving the dynamic data feeds in response to calls from the interactive objects.

33. The computer-readable media of claim 32, further encoded with instructions for serving a user interface operative to configure presentation of the content items in the web pages in response to user input from respective users of client mobile devices.

34. The computer-readable media of claim 32, further encoded with instructions for configuring the mobile client application to automatically designate the host as a recipient of the content items.

35. The computer-readable media of claim 32, further encoded with instructions for configuring the interactive objects to display an index of selected content items when operating on the web pages.

36. The computer-readable media of claim 32, further encoded with instructions for configuring the interactive objects to display an index of selected content items in an ordered list.

37. A computer-readable media for collecting electronic content from wireless mobile clients, encoded with instructions operative for:
configuring a mobile client application to capture electronic content using a capture device of a client mobile device, to time stamp the electronic content with a capture time, and to upload the electronic content and timestamp to an automatically designated host;
distributing the mobile client application for installation on a plurality of wireless mobile clients;
receiving the electronic content at the automatically designated host from the wireless mobile clients; and
storing the electronic content.

38. The computer-readable media of claim 37, further encoded with instructions for serving a user interface operative to configure presentation of the electronic content on content pages in response to input from users of the plurality of wireless mobile clients.

39. The computer-readable media of claim 37, further encoded with instructions for organizing the electronic content received by the designated host according to index data automatically provided by the mobile client application, the index data indicating at least a respective times of recording and client identifiers for the electronic content.

40. The computer-readable media of claim 39, further encoded with instructions for serving dynamic data feeds each operative to configure a respective one of distributable embedded applications configured for presenting the electronic content.

41. A computer-readable media for configuring presentation of electronic content from client wireless mobile clients, the media encoded with instructions for:
serving a user interface operative to configure presentation of electronic content on Internet web pages in response to input from users of a plurality of wireless mobile clients;
configuring data feeds in response to the input to cause embedded applications in the Internet web pages to output the electronic content organized by associated time stamps associated with each item of electronic content; and
serving the data feeds to the Internet web pages to cause the electronic content from a plurality of wireless mobile clients to be output from a plurality of network clients distinct from the plurality of wireless mobile clients.

42. The computer-readable media of claim 41, further encoded with instructions for configuring the embedded applications to receive the data feeds.
